(19) United States
(12) Patent Application Publication
(10) Pub. No.: US 2008/0265656 A1
(43) Pub. Date: Oct. 30, 2008

(54) Wheel, rim and process for manufacturing a wheel

(76) Inventor: Joachim Heyse, Wolfratshausen (DE)

Correspondence Address: GREER, BURNS & CRAIN, 300 S WACKER DR, 25TH FLOOR, CHICAGO, IL, 60606, US

(21) Appl. No.: 11/824,589

(22) Filed: Jun. 29, 2007

(30) Foreign Application Priority Data
Apr. 24, 2007 (DE) 10 2007 019 611.5

(51) Int. Cl. B60B 1/02; B29C 63/04; B60B 1/08; B60B 21/00

(52) U.S. Cl. 301/55; 301/58; 264/258; 301/95.102

(57) ABSTRACT

A method of manufacturing a bicycle type wheel, including placing a first fibrous fabric section onto a first mold part of a mold along the periphery of a rim, such that the first fabric section forms a rim flange, placing spokes on the first mold part at angles relative to one another such that the radially outwardly spoke ends rest on the first fabric section, placing at least one core on the first fabric section, placing at least one fabric strip onto an inner surface of a mold ring and placing the mold ring into the first mold part, the fabric strip forming at least part of the rim well, enveloping an inflatable tube in a fabric section and placing the tube into the first mold part, repeating the procedure for a second quantity of spokes, inflating the tube, curing the resin-impregnated materials, removing from the mold an integral wheel.

The invention relates to a wheel, a rim and a method of manufacturing a wheel, in particular for bicycles. Although the invention will be described below with respect to application in a bicycle, the invention may be employed with other unicycles or multi-cycles, in particular with bicycle trailers, scooters, or wheelchairs.

In the field of high and highest quality sports products, and in the field of racing, the weight of components is paramount in significance. To reduce the weight of wheels and rims, rims of fiber-reinforced plastics have become known which while being reduced in total weight achieve a comparable or even higher stability than do metal rims.

Against this technical background it is the object of the present invention to provide a wheel and a rim which achieve a high quality while also allowing a low weight with a high stability. It is another aspect to provide rims and wheels that are simple to manufacture.

This object is solved by the method of the invention with the features of claim 1. The rim according to the invention is the object of claim 26 and the wheel according to the invention is the object of claim 28. Preferred configurations and specific embodiments are the objects of the subclaims.

In the method of manufacturing a wheel according to the invention, which is in particular suitable to be employed for a bicycle, the wheel to be manufactured comprises a hub body, a rim, and spokes connecting the hub body and the rim. Therein the rim comprises a rim well, a rim base, and rim flanges connecting the rim well and the rim base. The method according to the invention comprises the following steps in the order indicated or in any other suitable sequence:

A first multi-layered, integral woven fabric section of a material containing fibrous fabric is placed onto a first mold part of a manufacturing mold along the periphery of the rim to be manufactured. The fabric section is being positioned such that the first fabric section is suitable and intended for forming a rim flange of the rim to be manufactured.

A first quantity of spokes is placed on the first mold part at predetermined angles relative to one another such that the radially outwardly spoke ends in particular rest immediately on the first fabric section.

Furthermore at least one core is placed onto the first fabric section which is matched in particular to the corresponding inner contour of the rim to be manufactured.

At least one fabric strip is placed onto an inner surface of a mold ring, and the mold ring is placed into the first mold part, such that the fabric strip forms at least part of the rim well of the rim to be manufactured.

Furthermore, an inflatable or fluid-refillable tube is enveloped in a fabric section and the inflatable tube is placed into the first mold part.

At least a second quantity of spokes is placed on the manufacturing mold at predetermined angles relative to one another such that the radially outwardly spoke ends rest at least in part on the core.

A second multi-layered, integral fabric section of a material containing fibrous fabric is placed onto a second mold part of the manufacturing mold along the periphery of the rim to be manufactured, such that the second fabric section is suitable and intended for forming the second rim flange.

Thereafter the manufacturing mold is closed and the inflatable tube is inflated to an elevated pressure. If necessary, the manufacturing mold is brought to a specified temperature at which it is kept for an appropriate time.

After curing the resin-impregnated fiber-reinforced materials, the wheel is removed from the manufacturing mold. The wheel as a whole is an integral, unitary element.

The method according to the invention allows to manufacture wheels having a low weight and being highly resistant to stress. The achievable quality is high.

Preferably the first and/or the second fabric section are configured as fabric tubes which, lying flat, form a multi-layered and integral fabric section. Employing a fabric tube as a first or second fabric section offers significant advantages since the flat-lying fabric tube comprises two layers immediately upon each other. The flat-lying fabric tube exhibits particularly good draping properties so as to allow a virtually ideal positioning of the fabric section the length of the periphery of the first form part.

The rim flanges extend from the minimum inner rim diameter to the maximum outer rim diameter such that in positioning, the fabric material forming the rim flange must exhibit draping properties so as to compensate for the different circumferential distances without causing damage to the construction of the rim flanges. This is presently achieved.

The use of a fabric tube which lying flat forms a rim flange has surprisingly shown excellent draping properties so as to obtain a high quality rim flange wherein a consistently high quality will be achieved both in the radially inwardly and in the radially outwardly areas.

While conventional fabric strips often exhibit a considerable influence on the fabric structure and the width of mesh over the circumference of the rim flange, using a flat-lying fabric tube allows a high-quality configuration of the rim flange.

As an alternative or supplement to using a fabric tube it is also conceivable to fold over or to crease the first and/or the second fabric section lengthwise along a folding edge to thus form an integral fabric section correspondingly comprising double the number of layers.

An alternative configuration provides for the multi-layered and integral first and/or second fabric section to be manufactured of a fabric strip which is folded over or creased along at least one folding edge to thus form the integral and multi-layered fabric section.

For example a one-layer, rectangular fabric strip of a specific length and width may be positioned on a support and folded along its centerline to provide a two-layer, integral fabric section.

It is also conceivable to place an e.g. rectangular fabric strip on a support wherein about one fourth of the width is folded toward the center so as to create on the whole a tube-like fabric section that is cut open lengthwise. In this configuration the abutting edge of the two sides lies in the center of the fabric section. The abutting edge may certainly be positioned nearer the one or the other edge. A fabric section thus folded exhibits properties similar to those of the fabric tube described above, in particular nearly the same draping properties, so as to allow an even placing of the first fabric section on the first mold part, in particular with but not limited to the use of prepregs.

Due to the fact that no outer edges of the fabric strip are positioned against the radially inwardly or the radially outwardly rim edges, draft to the fabric is avoided, allowing a high planar quality of the rim flanges.

To assist the draping properties, all of the above described configurations provide that the first and/or the second fabric section be preferably made of a woven fabric whose threads are oriented at an angle to the longitudinal axis of the fabric section. Preferably the angle is at least 15°. Given an angle of 45° both fiber directions in a rectangular fabric have the same angle to the longitudinal axis of the fabric section. This allows for particularly good draping properties where local differences of the fabric quality in the rim flange are avoided as much as possible.

Preferred specific embodiments of the method according to the invention provide for the core to be positioned onto the first fabric section in the vicinity of the rim base and in particular immediately on the rim base.

The core is in particular dimensioned somewhat larger so as to exert an increased pressure on the adjacent layers during curing in the manufacturing mold.

The core may be designed integral and for example slotted. The core may, however, consist of multiple parts to be placed along the circumference.

The use of two or more separate cores arranged at different radial distances is likewise possible.

The mold ring preferably has a radially inwardly rounded contour matched to the profile of the rim well. In this way the mold ring immediately predetermines the shape of the rim well so as to achieve a high grade of reproducibility.

The mold ring may be designed integral and comprise a slot.

Preferably the mold ring is firstly covered with a fabric tube or with a fabric section consisting of a fabric strip folded over, and thereafter with a fabric strip which in the finished wheel forms the rim well.

The mold ring may comprise approximately parallel side faces such that when the side faces are covered with fabric material, rims having rim flanges may be manufactured.

All of the configurations provide for the mold parts and the mold ring to be coated with a release agent in particular before placing the fabric material thereon so as to prevent the fabric material from adhering to the mold parts or the mold ring.

The inflatable tube may be enveloped in a fabric tube as the fabric section before being placed. However, it is possible to wrap the inflatable tube into at least one fabric strip, or to place on the inflatable tube individual fabric strips extending around the tube.

It is generally possible to radially position the inflatable tube, which is enveloped in the fabric section, in different radial positions. In a preferred embodiment the inflatable tube is placed into the first mold part between the mold ring and the core. This guarantees effective application of pressure through the inflatable tube such that both the rim well and the radially inner region for receiving the spokes are configured correspondingly.

Other configurations may provide for the inflatable tube to be placeable into the first mold part between the core and the rim base; for example with the core being inserted radially farther outwardly and with the core being intended to provide the support for the rim well.

Preferably the procedure is started by placing a hub body holder centrally relative to the manufacturing mold onto which there are then placed, a first or (in the mold) bottom outer hub cover, a first or bottom inner hub cover, a second or (in the mold) top inner hub cover, and a second or top outer hub cover, in this order.

Thereafter there are inserted, between the second outer hub cover and the second inner hub cover, the radially inwardly spoke ends of the first or top spokes, before bringing the second outer hub cover in contact with the second inner hub cover and firmly joining same by means of a bonding agent, in particular a resin, to form a second hub cover. In this way the spokes are firmly retained at the hub cover.

Correspondingly there are inserted, preferably between the first outer hub cover and the first inner hub cover, the radially inwardly spoke ends of the second or bottom spokes, before bringing the first outer hub cover in contact with the first inner hub cover and firmly joining same by means of a bonding agent to form a first hub cover. Thus the hub covers practically represent the hub flanges of commercial wheels from which the spokes extend radially outwardly.

Particularly preferably the spokes comprise a spoke body over the length of which the individual fibers forming the spoke body extend outwardly such that the individual fibers protruding beyond the radially inwardly end of the spoke body are fanned out between the first and the second outer and inner hub covers, so as to be firmly embedded between the corresponding inner hub cover and outer hub cover by means of the bonding agent or the resin. This achieves high resistance to stress.

Preferably the correspondingly configured radially outwardly spoke ends of the first and the second spokes are correspondingly fanned out as they are placed onto the manufacturing mold, such that the spokes are received at the rim flanges also in a spread out, fanned shape, which allows manufacturing a robust and lightweight rim since no additional reinforcements for spoke nipples etc. need to be provided.

After curing the rim and the spokes and hub covers bonded thereto, a hub tube or a hub sleeve is preferably inserted between the first and the second hub cover which is dimensioned such that a corresponding or the desired spoke tension is generated. The hub tube between the hub covers is bonded with the hub covers by means of a suitable bonding agent such as a corresponding resin.

All cases provide for employing a preimpregnated fabric material in the shape of e.g. prepregs. However, dry fabric material may be used which is then impregnated or coated with a suitable resin. Furthermore it is possible to partly use prepregs while dry fabric material is partly used which during manufacturing is impregnated or coated with a resin.

The rim according to the invention is in particular provided to be used with a bicycle and comprises at least a rim well, a rim base, and rim flanges connecting the rim well and the rim base. The rim according to the invention preferably consists substantially and it may consist entirely of a fiber-reinforced material. The rim flanges of the rim according to the invention consist of an integral and multi-layered fabric section, which fabric sections comprise at least at the radially outwardly edges, fabric layers that are folded upon each other or creased.

In a more specific embodiment of the rim according to the invention, each rim flange consists of an integral and multi-layered fabric section. Therein the fabric sections of the two rim flanges comprise at one of their radial edges, fabric layers that are folded upon each other or creased. It is in particular also possible that fabric layers folded upon each other are provided at a radially inwardly and at a radially outwardly edge.

The wheel according to the invention is in particular provided to be used with a bicycle and comprises a rim, a hub body, and spokes connecting the rim and the hub body. The wheel according to the invention preferably consists at least substantially of a fiber-reinforced material. The rim of the wheel according to the invention comprises a rim well, a rim base, and rim flanges connecting the rim well and the rim base. At least one rim flange is formed through a multi-layered and integral fabric section of a material comprising fibrous fabric.

The wheel according to the invention can be manufactured in a high quality, wherein the weight is particularly low.

The quantity of spokes of the wheel according to the invention is in particular at least five and in particular at least eight and preferably between twelve and thirty.

Preferably one of the rim flanges is formed by a first multi-layered and integral fabric section and the other rim flange is formed by a second multi-layered and integral fabric section.

As described above, the fabric sections may be configured as fabric tubes or be formed of e.g. a rectangular fabric strip that is folded over along at least one folding edge to form an integral and multi-layered fabric section.

Preferably the core rests on the rim base. The core may consist of multiple parts placed along the circumference. Two or more separate cores may be provided which are arranged at different radial distances.

The rim well may be formed by one or more fabric strips or by one fabric tube and one fabric strip.

In all of the embodiments it is possible to provide a transverse web to reinforce the rim between the rim base and the rim well. The transverse web may be formed by a fabric section, a fabric strip or by a fabric tube.

The hub body may comprise a first hub cover which is formed by a first outer hub cover and a first inner hub cover connected therewith. Furthermore a second hub cover is provided which is formed by a second inner hub cover and a second outer hub cover connected therewith. A hub sleeve or a hub tube is provided between the two hub covers.

Preferably the fibers are fanned out at the spoke ends and received to be form-fitting at the rim or at the hub covers.

To manufacture a wheel in particular for bicycles, comprising a hub body, a rim and spokes connecting the hub body and the rim, wherein the rim comprises a rim well, a rim base and rim flanges connecting the rim well and the rim base, a device is used which comprises a manufacturing mold.

The manufacturing mold comprises a first mold part intended to receive a first multi-layered and integral fabric section of a material comprising fibrous fabric. The first mold part is configured approximately as a circle, having a cross-section matched to the outer contour of a rim half.

A segmentation ring is provided which is positioned centrally in the manufacturing mold, serving for angular adjustment of the spokes which are inserted in recesses of the segmentation ring.

A core is provided which is placed onto the first mold part in the region of the rim base.

Furthermore, a mold ring is used whose inner surface is matched to the shape of the rim well.

Moreover, a second mold part is provided intended to be placed on the first mold part and connected with it to close the manufacturing mold.

Other advantages and possibilities of application of the present invention can be taken from the exemplary embodiment which will now be explained with reference to the accompanying figures.

The Figures show in:

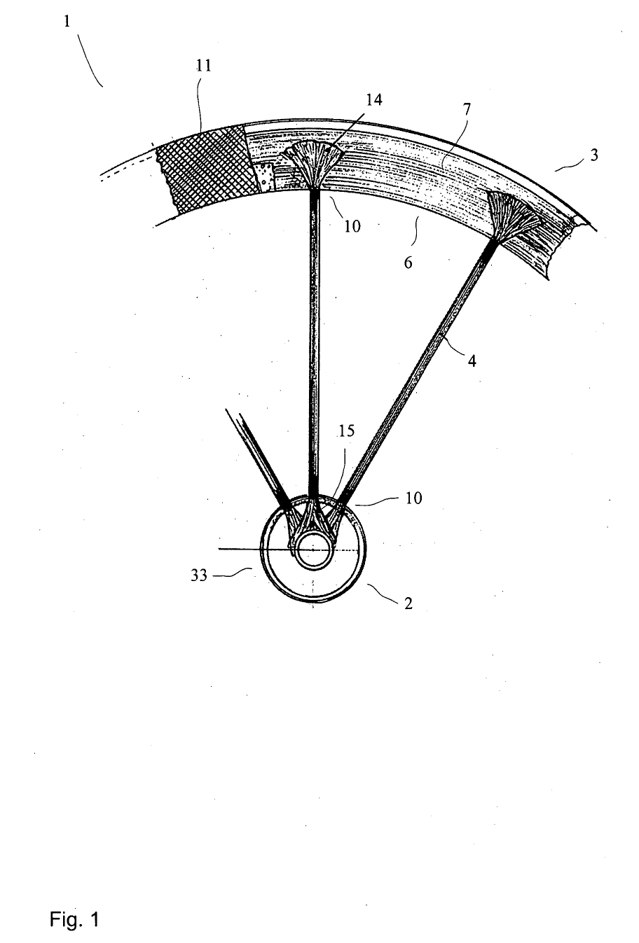

FIG. 1 a side view of a sectional detail of a wheel exhibiting radial spoke orientation;

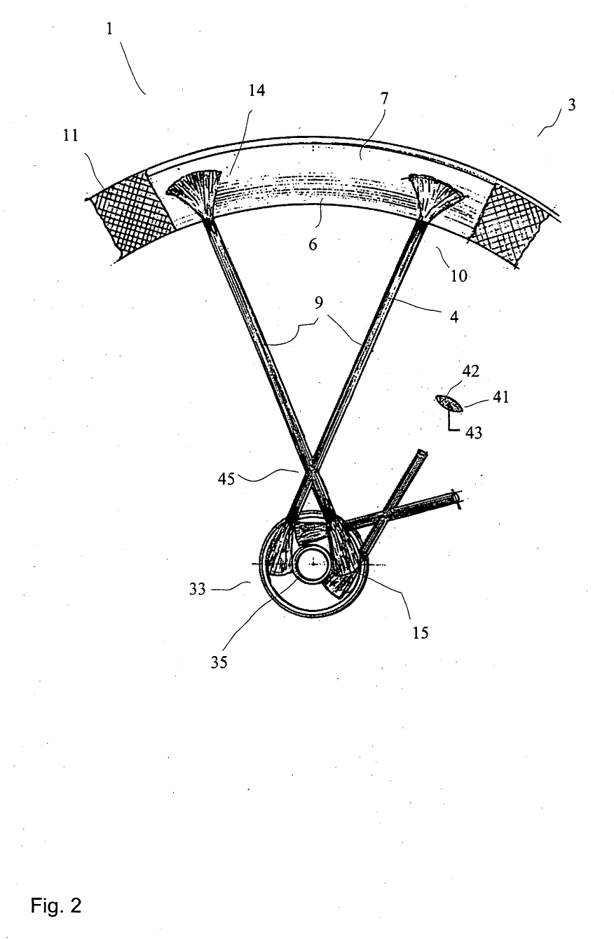

FIG. 2 a sectional detail of a side view of a wheel with crossed spokes;

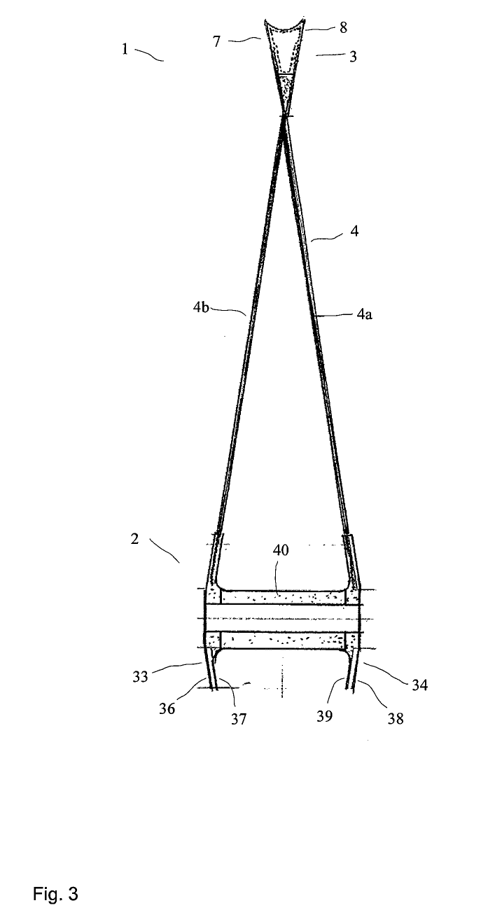

FIG. 3 a cross-sectional view of a wheel according to the invention;

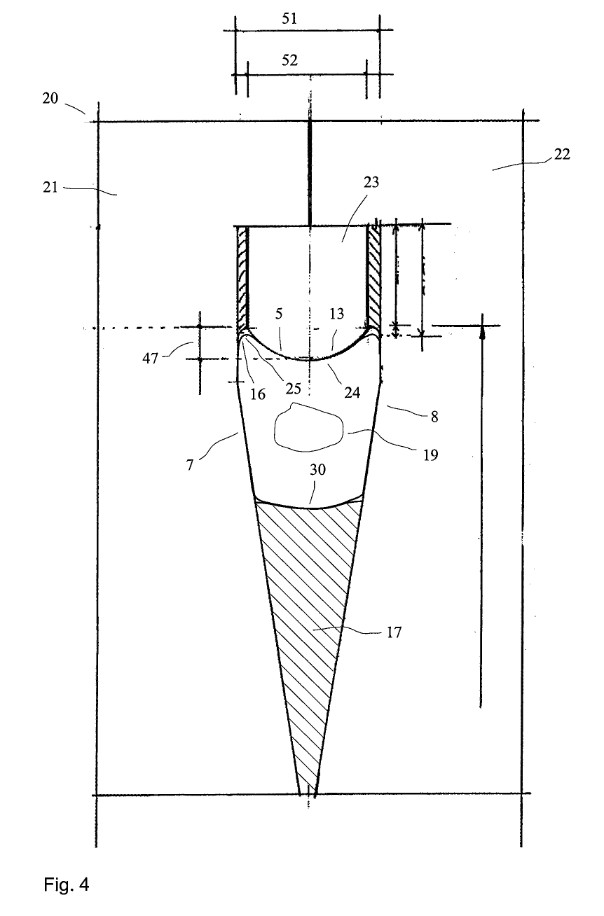

FIG. 4 a cross-section of the manufacturing mold and the rim according to FIG. 3;

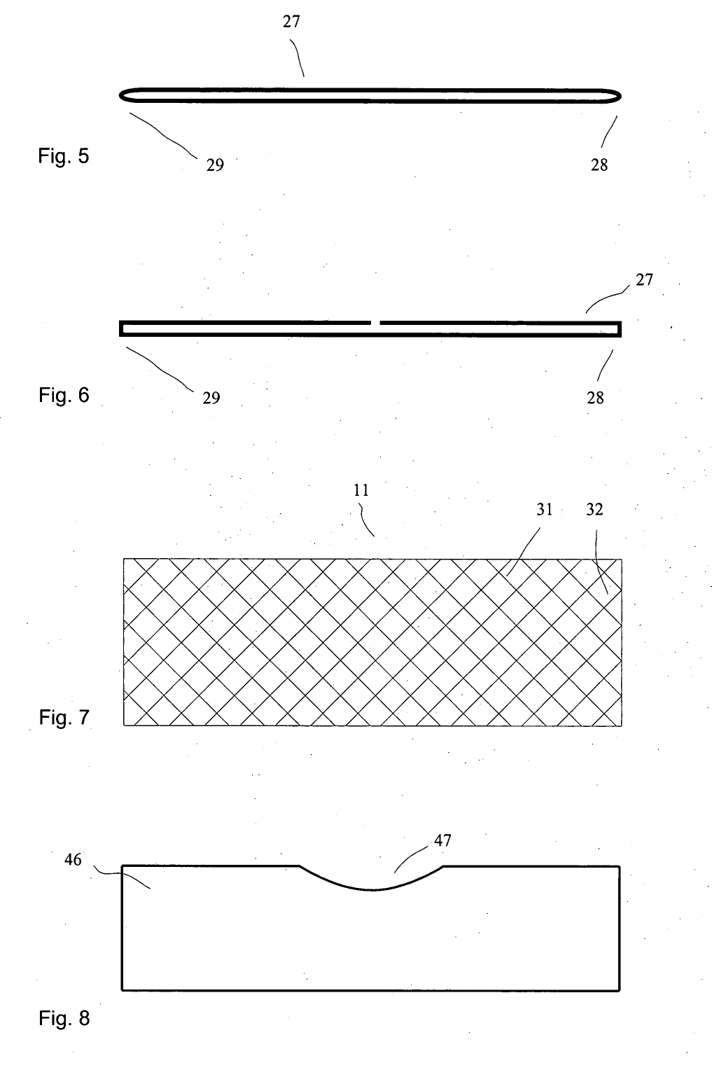

FIG. 5 a schematic view of a fabric tube;

FIG. 6 a schematic view of a folded over fabric strip;

FIG. 7 a top view of a fabric section; and

FIG. 8 a schematic view of a mold half for manufacturing the spokes.

An exemplary embodiment of the present invention will now be described with reference to the accompanying Figures.

For manufacturing the wheel 1, firstly the spokes 4 are manufactured which according to the illustration in FIG. 1 may comprise a single body 9 as it is provided for radial spoking, or which may comprise two crossed spoke bodies 9 as illustrated in FIG. 2.

For manufacturing the spokes 4 illustrated in FIG. 1, a cover layer 41, in the present exemplary embodiment configured as a one-layer arrangement, is placed into a first mold half 46 after providing the mold half 46 with a release agent to avoid adherence of the finished spokes 4. Thereafter, a plurality of parallel unidirectional fibers 42 is placed on the cover layer 41 to receive the spoke tension. Care is taken that the hollow 47 of the mold half 46 be entirely filled or that the fibers placed inside exceed the available cross-sectional area.

A cover layer 41 as well as a corresponding plurality of fibers 42 is also placed in a second mold half.

The length of the mold half 46 corresponds to the spoke length between the hub body 2 and the rim 3. The length of the fibers placed in the mold half 46 is longer than the length of the mold half 46, such that the individual fibers 41 protrude beyond the ends of the mold half 46, preferably between approximately one and three centimeters, preferably approximately 2 centimeters.

The protruding fibers 42 can thus be fanned out as the spoke is manufactured or as the spoke is incorporated into the rim 3 or the hub body 2. By means of the spoke 4 it is thus possible to guarantee a secure and firm seat in the rim or in the hub body without having to incorporate complicated reinforcement layers or the like into the structural elements to guarantee the required hold.

The spokes 4 are prefabricated separately and cured separately, allowing stocking for wheel production.

For manufacturing the spokes and for manufacturing the rims 3 or the entire wheel 1 it is generally possible to use pre-impregnated fiber fabric but it is also possible and preferred to use dry fibers or fiber fabric which are subsequently impregnated with a resin during manufacture.

For manufacturing the wheel 1, a section of which is illustrated in FIG. 1, a mold 20 comprising mold parts 21 and 22 is used (see FIG. 4).

The mold part 21, placed level on a support, is coated with a release agent as is the mold part 22. Thereafter, a fabric section 11 is placed in a circle on the mold part 21 along the periphery of the rim 3 to be manufactured such that the fabric section 11 will form the rim flange 7 in the later rim 3. In analogy thereto, a fabric section 12 which will form the rim flange 8 is placed into the mold part 22 of the manufacturing mold 20.

The fabric sections 11 and 12 employed may be the fabric sections illustrated in the FIGS. 5 and 6. Preferably the fabric section illustrated in FIG. 5 is used which is configured as a fabric tube 26. The fabric tube 26 comprises fibers 31 and 32 as illustrated in FIG. 7, all of which are oriented approximately at an angle of 45° to the longitudinal direction of the fabric section.

By using a fabric tube 26 comprising fibers 31 and 32 arranged at angles, superior draping properties of the fabric section 11 are achieved such that the fabric section 11 can be excellently placed in the mold 21 while also retaining the fabric quality over the circumference and across the radial direction of the rim flange 7 in a consistent, homogeneous quality.

In this way a high degree of quality in manufacturing the rim and the wheel is achieved. In the prior art in contrast to this, strips placed on top tend to crease at the radially inwardly or at the radially outwardly places of the rim. Concurrently the mesh distance and the mesh width varies such that no homogeneous properties of the rim and the wheel are achieved.

After placing the fabric section 11, the ends 14 of the spokes 4 assigned to the rim flange 8 are placed onto the fabric section 11, wherein the protruding fibers 42 are fanned out to guarantee as large a hold in the rim as possible. It is also possible that the fibers 42 had already been fanned out in manufacturing the spoke 4 and cured flat in a fanned out condition such that the fanned out and cured spoke is placed on the fabric section 11 which is placed on the mold part 21.

In the radially inwardly region there has been centered relative to the mold part 21a hub body holder 35 onto which the first outer hub cover 36, the first inner hub cover 37 and thereafter the second inner hub cover 38 and the second outer hub cover 39 are slipped. In the radially inwardly region between the second outer hub cover 39 and the second inner hub cover 38 the fibers 42 protruding at the inwardly spoke end 15 are fanned out and positioned between the covers 38 and 39. After adding a bonding agent which may for example be a resin, the covers 38 and 39 are pressed upon each other and bonded to form a second hub cover 34. The first outer hub and inner hub covers 36 and 37 are later worked in analogy thereto.

A core 17 is placed on the spoke ends 14 which are positioned on the fabric section 11, being approximately triangular in cross-section and provided to be positioned in the area of the rim base.

A mold ring 23, whose radially inwardly surface 24 is matched to the desired rim well profile is covered with a fabric strip at least on the inwardly surface 24. As an alternative or supplement thereto, a fabric tube may be placed on the inwardly surface 24 of the mold ring 23. Thereafter the mold ring 23 is placed in the mold part 21 such that a radial distance or gap remains between the core 17 and the mold ring 23.

An inflatable tube 19 enveloped in a fabric section 16 is inserted into the remaining gap. The fabric section 16 enveloping the inflatable tube may for example be configured as a fabric tube 25 which is mounted onto the inflatable tube 19. Alternatively the inflatable tube may be enveloped or wrapped in a fabric strip or the like before the inflatable tube 19 is placed into the gap.

The fabric section 16 reinforces the rim well in the radially outwardly area and on the sides, the rim flanges 7 and 8, which also comprise the brake-contact surfaces 47. In the radially inwardly area the fabric section 16 reinforces the rim 3 with a transverse web 30 such that the rim 3 is better suited for absorbing the loads occurring in braking.

After inserting the inflatable tube 19 the mold part 22 is placed onto the mold part 21 and the entire mold 20 is closed. After raising the pressure in the inflatable tube 19 the manufacturing mold 20 is brought up to a higher temperature level to accelerate the curing process.

At the same time or prior to this, the inflatable tube 19 is pressurized to effect a pressure bonding of the individual fabric sections.

After curing and cooling of the manufacturing mold 20 the manufacturing mold 20 is opened and the wheel removed.

It is a significant advantage of the wheel 1 that it consists uniformly of the same or at least a similar material such that the rim, the spokes, and the hub body exhibit the same coefficient of thermal expansion. In conventional wheels of fibrous composite materials having metal spokes, the spoke tension may slacken as the wheel heats up since metal spokes and fibrous composite materials differ in performance. Fibrous composite materials may exhibit negative coefficients of thermal expansion which can further intensify a reduction of spoke tension. The wheel 1 does not exhibit these disadvantages.

Compared to the known three-spoke wheels of fibrous composite material the significant advantage of a much higher lateral rigidity is achieved.

The spokes are tensioned by inserting a hub sleeve 40 between the hub covers 33 and 34. The hub sleeve 40 is bonded with the hub covers 33 and 34 such that on the whole an integral wheel 1 is present which consists of fibrous composite material.

It is a significant advantage of the wheel that the spokes 4 run in a straight line from their origin in the rim until and into the hub cover or the hub flange. This is achieved in that the rim is substantially triangular in cross-section with the inclination angle set so as to obtain a straight-lined form.

The exemplary embodiment of a wheel 1 illustrated in FIG. 2 shows crossed spokes 4, wherein each spoke 4 comprises two crossed spoke bodies 9 lying on a plane and integrally connected with one another. Manufacture is performed using a mold into which crossed fiber bundles and fiber arrangement are inserted to integrally manufacture the crossed spokes. At the four ends of the spoke bodies 9, the individual fibers 42 protrude from the spoke bodies 9 to be integrated into the rim or into the hub body to be form-fitting.

FIG. 2 also illustrates a cross-section of the spoke body 9 which in this exemplary embodiment is approximately elliptical to achieve a low drag.

1. A method of manufacturing a wheel, in particular for bicycles, comprising a hub body and a rim and spokes connecting the hub body and the rim, wherein the rim comprises a rim well, a rim base and rim flanges connecting the rim well and the rim base, comprising the following steps:
placing at least one first multi-layered and integral fabric section of a material comprising fibrous fabric onto a first mold part of a manufacturing mold along the periphery of the rim, such that the first fabric section is suitable for forming a rim flange,
placing a first quantity of spokes on the first mold part at predetermined angles relative to one another such that the radially outwardly spoke ends rest on the first fabric section,
placing at least one core on the first fabric section,
placing at least one fabric strip onto an inner surface of a mold ring and placing the mold ring into the first mold part, wherein the fabric strip forms at least part of the rim well,
enveloping an inflatable tube in a fabric section and placing the inflatable tube into the first mold part,
placing at least a second quantity of spokes on the manufacturing mold at predetermined angles relative to one another such that the radially outwardly spoke ends rest on the core,
placing a second multi-layered and integral fabric section of a material comprising fibrous fabric on a second mold part of the manufacturing mold along the periphery of the rim, such that the second fabric section is suitable for forming the second rim flange,
closing the manufacturing mold,
inflating the inflatable tube to an elevated pressure,
curing the resin-impregnated fiber-reinforced materials,
removing from the manufacturing mold the wheel which as a whole is an integral element.

2. The method according to claim 1, wherein the first and/or the second fabric section, is configured as a fabric tube which, lying flat, forms a multi-layered and integral fabric section.

3. The method according to claim 1, wherein the first and/or the second fabric section are folded over along at least one folding edge to form an integral and multi-layered fabric section.

4. The method according to claim 2, wherein the multi-layered and integral first and/or second fabric section consists of a fabric strip folded over along at least one folding edge to form an integral and multi-layered fabric section.

5. The method according to claim 1, wherein the fabric fibers are oriented at an angle of at least 15° and preferably at an angle of 45° to the longitudinal extension of the fabric section.

6. The method according to claim 1, wherein the at least one core is placed on the first fabric section in the vicinity of the rim base.

7. The method according to claim 1, wherein the at least one core consists of multiple parts which are placed along the circumference.

8. The method according to claim 1, wherein the mold ring has a radially inwardly rounded contour which is matched to the profile of the rim well.

9. The method according to claim 1, wherein the mold ring is configured to be integral and comprises a slot.

10. The method according to claim 1, wherein firstly a fabric tube and thereafter a fabric strip is placed on the mold ring.

11. The method according to claim 1, wherein the mold ring comprises approximately parallel side faces.

12. The method according to claim 1, wherein fabric material is placed on the side faces and the inner surface of the mold ring.

13. The method according to claim 1, wherein the mold parts and the mold ring are coated with a release agent before fabric material is placed thereon.

14. The method according to claim 1, wherein the inflatable tube is enveloped in a fabric tube as the fabric section.

15. The method according to claim 1, wherein the inflatable tube is wrapped in at least one fabric strip.

16. The method according to claim 1, wherein the inflatable tube is inserted into the first mold part between the mold ring and the core.

17. The method according to claim 1, wherein the inflatable tube is inserted into the first mold part between the core and the rim base.

18. The method according to claim 1, wherein a hub body holder is placed centrally relative to the manufacturing mold, onto which a first outer hub cover, a first inner hub cover, a second inner hub cover, and a second outer hub cover are slipped.

19. The method according to claim 18, wherein there are inserted, between the second outer hub cover and the second inner hub cover, radially inwardly spoke ends of the first spokes, before bringing the second outer hub cover in contact with the second inner hub cover and firmly joining these by means of a bonding agent to form a second hub cover.

20. The method according to claim 19, wherein there are inserted, between the first outer hub cover and the first inner hub cover, the radially inwardly spoke ends of the second spokes before bringing the first outer hub cover in contact with the first inner hub cover and firmly joining these by means of a bonding agent to form a first hub cover.

21. The method according to claim 19, wherein the radially inwardly spoke ends of the first and the second spokes are fanned out as they are placed between the corresponding first and second outer hub and inner hub covers.

22. The method according to claim 21, wherein the radially outwardly spoke ends of the first and the second spokes are fanned out as they are placed on the manufacturing mold.

23. The method according to claim 1, wherein the spoke tension is generated after curing in that a hub tube is inserted between the hub covers.

24. The method according to claim 1, wherein preimpregnated fabric material is used.

25. The method according to claim 1, wherein dry fabric material is used which is coated with resin.

26. A rim, in particular for a bicycle, comprising at least a rim well, a rim base, and rim flanges connecting the rim well and the rim base and substantially consisting of a fiber-reinforced material, characterized in that the rim flanges consist of an integral, multi-layered fabric section, wherein the fabric sections comprise fabric layers that are folded upon each other at least at the radially outwardly edges.

27. The rim according to claim 26, wherein each rim flange consists of an integral, multi-layered fabric section, wherein the fabric sections comprise fabric layers folded upon each other at least at one radial edge.

28. A wheel, in particular for a bicycle, comprising a rim, a hub body, and spokes connecting the rim and the hub body and substantially consisting of a fiber-reinforced material, wherein the rim comprises a rim well, a rim base, and rim flanges connecting the rim well and the rim base, wherein at least one rim flange is formed by a multi-layered and integral fabric section of a material comprising fibrous fabric.

29. The wheel according to claim 28, wherein the quantity of spokes is at least five and in particular at least eight and preferably between twelve and thirty.

30. The wheel according to claim 28, wherein one of the rim flanges is formed by a first multi-layered and integral fabric section and the other rim flange, by a second multi-layered and integral fabric section.

31. The wheel according to claim 30, wherein the first and/or the second fabric section is configured as fabric tubes which, lying flat, forms a multi-layered and integral fabric section.

32. The wheel according to claim 30, wherein the multi-layered and integral first and/or second fabric section consists of a fabric strip folded over along at least one folding edge to form an integral and multi-layered fabric section.

33. The wheel according to claim 28, wherein a core rests on the rim base.

34. The wheel according to claim 28, wherein the core consists of multiple parts placed along the circumference.

35. The wheel according to claim 28, wherein two or more separate cores are provided.

36. The wheel according to claim 28, wherein the rim well is formed by a fabric tube and/or a fabric strip.

37. The wheel according to claim 28, wherein a transverse web is provided between rim base and rim well for reinforcing the rim, formed by a fabric tube or a fabric section.

38. The wheel according to claim 28, wherein the hub body comprises a first outer hub cover and a first inner hub cover connected therewith, a second inner hub cover and a second outer hub cover connected therewith, and a hub sleeve positioned between the hub covers, wherein the radially inwardly spoke ends are received between the corresponding hub covers.

39. The wheel according to claim 38, wherein the radially inwardly spoke ends of the first and the second spokes are fanned out.

40. The wheel according to claim 28, wherein the radially outwardly spoke ends of the first and the second spokes are fanned out and thus received in the rim.

41. The wheel according to claim 28, wherein preimpregnated fabric material is used.

42. The wheel according to claim 28, wherein dry fabric material is used at least in part which is coated with resin.

43. A device for manufacturing a wheel in particular for bicycles, comprising a hub body, a rim and spokes connecting the hub body and the rim, wherein the rim comprises a rim well, a rim base, and rim flanges connecting the rim well and the rim base,
wherein a manufacturing mold is provided which comprises a first mold part intended to receive a first multi-layered and integral fabric section of a material comprising fibrous fabric,
wherein the first mold part is configured approximately as a circle, having a cross-section matched to the outer contour of a rim half,
wherein a segmentation ring is provided which is centrally positioned in the manufacturing mold, serving for angular adjustment of the spokes which are inserted in recesses of the segmentation ring,
wherein a core is provided which is placed onto the first mold part in the region of the rim base,
wherein a mold ring is provided whose inner surface is matched to the shape of the rim well,
wherein a second mold part is provided intended to be placed on the first mold part and be connected with it to close the manufacturing mold.
